(19) United States
(12) Patent Application Publication
(10) Pub. No.: US 2002/0161662 A1
(43) Pub. Date: Oct. 31, 2002

(54) Method of displaying a shopping summary to a shopper who accesses an electronic commerce web site

(75) Inventors: Roger Bredow, Laurenceville, GA (US); Jon Dunfee, Atwood, IN (US); James Everett Sapp, Doraville, GA (US); Matthew Bunkley Trevathan, Kennesaw, GA (US)

Correspondence Address: David R. Irvin, IBM Corporation T81/062, P.O. Box 12195, Research Triangle Park, NC, 27709, US

(73) Assignee: International Business Machines Corporation, Armonk, NY

(21) Appl. No.: 09/845,542

(22) Filed: Apr. 30, 2001

(51) Int. Cl. G06F 17/60

(52) U.S. Cl. 705/26

(57) ABSTRACT

An electronic-commerce (e-commerce) customer is provided with a convenient way of calling for a shopping summary. The customer's web browser awaits a right-click from the customer's mouse upon an e-commerce web page. Upon detection of a right-click, the browser checks to see if a shopping summary is currently shown. When the shopping summary is shown at the time of the right-click, the web browser moves to a state wherein the summary is not show. When the shopping summary is not shown, the web browser moves to a state wherein the shopping summary is shown. In one embodiment, the summary appears as an overlay upon the web page. In another embodiment, the summary appears in a second web page that the browser opens upon detection of a right-click. The shopping summary may include a shopping cart, or an auction-bid summary, or a summary of other kinds of on-line purchasing, bidding, selling, or renting activity.

### FIELD OF THE INVENTION

The present invention applies to electronic commerce, and more particularly to a method for displaying a shopping summary such as a shopping cart or an auction-bid summary to a customer who uses an electronic commerce web site.

### BACKGROUND

On-line commerce is now an important part of our economy, mainly because of the efficiency and the ready convenience that on-line commerce provides. As a general principle, ready convenience and good human factors go hand-in-hand. Moreover, each improvement in human factors opens the use of electronic commerce to a larger segment of the population.

Today, however, many would-be participants in electronic commerce (e-commerce) are limited by the capabilities of the computer terminals they use to gain access to e-commerce web servers. This limitation is often experienced, for example, by customers who shop on-line. Because the goods to be purchased are not actually seen by the customer at the time the goods are selected—rather, the goods are carried virtually in an abstract shopping cart—the customer is not able to keep track of purchases conveniently.

One way to address this problem is to provide an on-line customer with a web-page icon that allows him to link from the on-line shopping web page to the shopping cart. When the customer engages this icon, the screen of the customer's terminal leaves the shopping page and moves to the shopping cart. When the cart appears on the terminal's screen, however, the shopping page disappears.

Moreover, the icons needed to move from the shopping page to the cart, and then from the cart back to the shopping page, are not necessarily easily found in a busy environment. Thus the customer may remain somewhat unsure of what is in the shopping cart and what is not, and somewhat inconvenienced by the need to alternate between the shopping cart and the shopping pages. These same kinds of uncertainties and inconveniences inflict customers who bid in on-line auctions, who engage in on-line barter, and who arrange rentals and leases on line.

Thus there is a need for a more convenient way of providing shopping summaries that may be accessed easily by e-commerce customers, for example shopping carts and similar summaries of barter, rental, leasing, and auction activities, in order to provide the customer with a more convenient on-line experience, and to open the use of e-commerce to a wider spectrum of the population.

### SUMMARY OF THE INVENTION

The present invention enables an electronic commerce customer—for example, an online shopper or a participant in on-line auction, barter, rental, or leasing activity—with a convenient way of calling for a shopping summary. According to the present invention, the customer's client or terminal awaits a right-click from the customer's computer mouse upon a web page, for example upon an on-line shopping page or an on-line auction page. Upon detecting a right-click, the client determines whether a shopping summary is then shown on the client's display. When the shopping summary is shown at the time of the right-click, the client moves to a state wherein the summary is not show. When the shopping summary is not shown at the time of the right-click, the client moves to a state wherein the shopping summary is shown. Thus the present invention enables the customer to show and to retire the shopping summary at will by entering a computer mouse right-click.

In one embodiment of the invention, the shopping summary appears as an overlay upon an electronic commerce web page. In another embodiment, the shopping summary appears in a second web page that the client's browser opens upon detection of a right-click. The shopping summary may include a shopping cart, or an auction-bid summary, or a summary of other kinds of on-line purchasing, bartering, bidding, leasing, or renting activity. These and other aspects of the present invention will be more fully appreciated when considered in light of the following drawings.

### BRIEF DESCRIPTION OF THE DRAWINGS

FIG. 1 is a symbolic diagram of a computer system that may support the invention.

FIG. 2 is a flowchart that shows aspects of the operation of the invention.

FIG. 3 is a flowchart that shows how the present invention opens and closes a web page that includes a shopping cart.

FIG. 4 is a flowchart that shows how the present invention opens and closes an overlay that includes a shopping cart.

FIG. 5 is a flowchart that shows how the present invention opens and closes a web page that includes an auction-bid summary.

FIG. 6 is a flowchart that shows how the present invention opens and closes an overlay that includes an auction-bid summary.

### DETAILED DESCRIPTION OF THE INVENTION

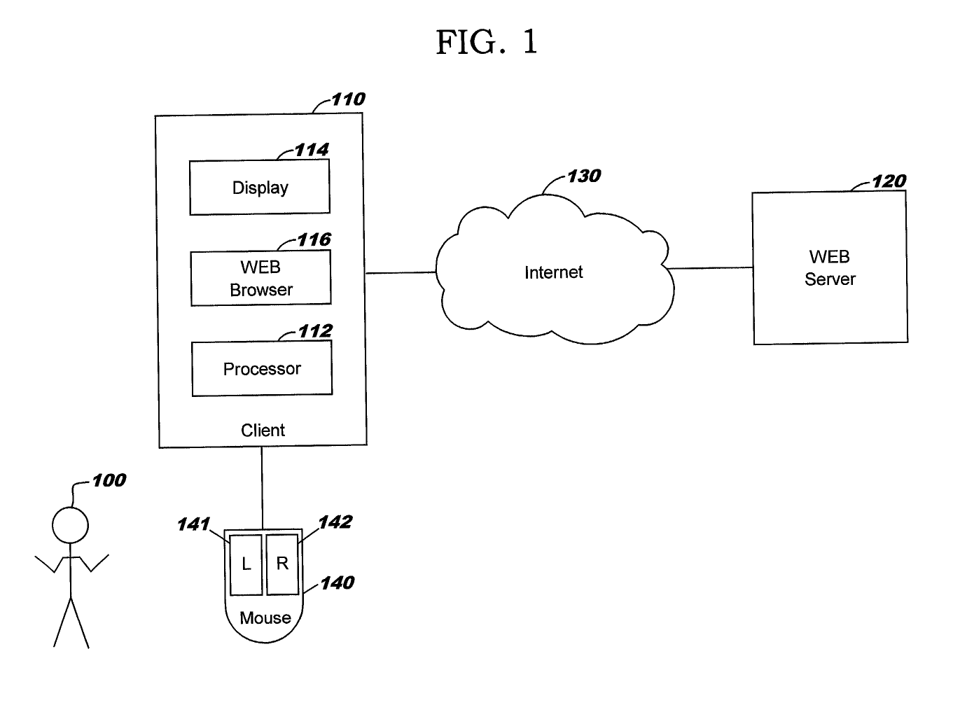

As shown in FIG. 1, a customer 100 uses a client 110 to engage a web server 120 in e-commerce activity such as on-line shopping. The client 110 and the web server 120 communicate over the Internet 130 or over another communication network. The client 110 may be a personal computer or similar device, which may include a processor 112, a display 114, and a web browser 116, wherein the processor 112 controls the operation of the display 114 and the web browser 116, and accepts input from a computer mouse 140.

The computer mouse 140 includes a left input switch 141 and a right input switch 142, through which the customer 100 may interact with the processor 112. A “left click” results when the customer 100 momentarily closes the left input switch 141 of the mouse 140; similarly, a “right click” results when the customer 100 momentarily closes the right input switch 142 of the mouse 140. The processor 112 monitors the left input switch 141 and the right input switch 142, detects left clicks and right clicks, and accepts the clicks as input signals.

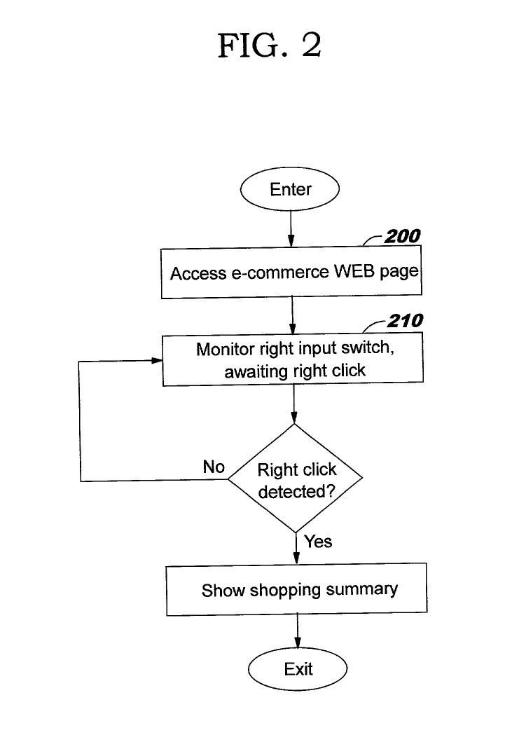

FIG. 2 shows aspects of the operation of the invention in the context of the structure shown in FIG. 1. As shown in FIG. 2, the customer 100 interacts with the client 110 to access an e-commerce web page provided by the web server 120 (step 200). The processor 112 the monitors the right input switch 142 of the computer mouse 140 for detection of a right click entered by the customer 100 (step 210). When a right click is not detected, the processor 112 continues to monitor (step 210). When a right click is detected, the processor 112 causes a shopping summary to show on the display 114 (step 220). The processor 112 may maintain the shopping summary itself, or it may initiate a request to the web server 120 for the shopping summary. Upon receipt of the shopping summary, the processor 112 instructs the web browser 116 to show the shopping summary on the display 114. The shopping summary may include a shopping cart, an auction bid summary, or any similar summary of the status of on-line purchasing, bidding, bartering, leasing, or rental activity.

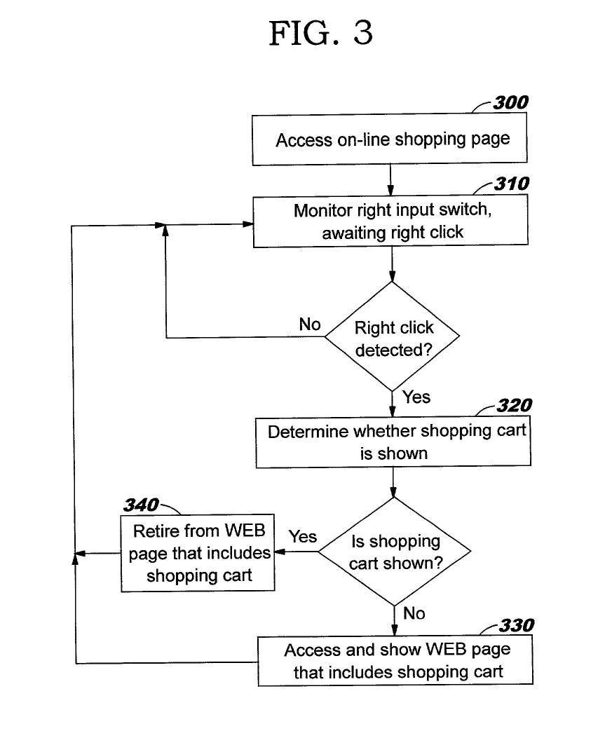

FIG. 3 shows further aspects of the operation of the invention. In FIG. 3, the customer 100 accesses an on-line shopping web page using the web browser 116 (step 300). The processor 112 monitors the right input switch 142 of the mouse 140 (step 310), awaiting a right click. When a right click is detected, the processor 112 determines whether the display 114 shows a web page that includes the shopping cart of the customer 100 (step 320).

When the display 114 does not show a web page that includes the shopping cart of the customer 100, the processor 112 instructs the browser 116 to access a web page on the server 120 that includes the shopping cart of the customer 100, and to show that web page on the display 114 (step 330). The processor 112 then returns to a state of monitoring the right input switch 142 of the computer mouse 140 (step 310). Otherwise (i.e., the display 114 shows a web page that includes the shopping cart of the customer 100 when the right click is detected), the processor 112 instructs the web browser 116 to retire the shopping cart by leaving the web page that includes the shopping cart, and go to an antecedent shopping page or to a subsequent shopping page (step 340), i.e., to stop showing the shopping cart. The processor 112 then returns to a state of monitoring the right input switch 142 of the computer mouse 140 (step 310).

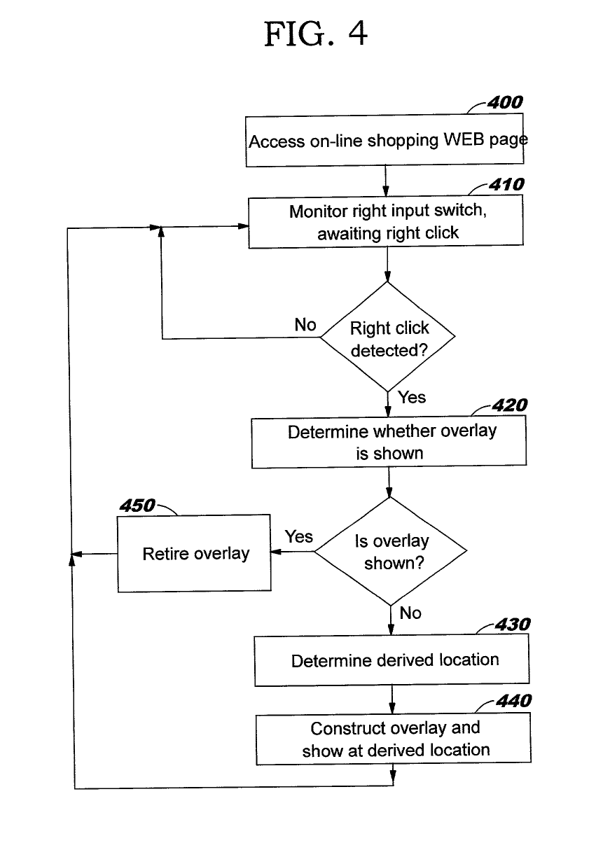

FIG. 4 shows aspects of the operation of another embodiment of the invention. In FIG. 4, the customer 100 accesses an on-line shopping web page using the web browser 116 of the client 110 (step 400). The processor 112 monitors the right input switch 142 of the mouse 140 (step 410). When a right click is detected, the processor 112 determines whether the display 114 shows a web-page overlay that includes the shopping cart of the customer 100 (step 420).

When the display 114 does not show an overlay that includes the shopping cart of the customer 100, the processor 112 reads the screen coordinates of the computer mouse 140 upon the display 114, and derives therefrom a screen location for showing an overlay (step 430). The derived location may be the location specified by the screen coordinates of the computer mouse 140, an offset of this location in the x or y directions upon the screen of the display 114, or some other location based upon the screen coordinates of the mouse 140. Alternately, the derived location may be a predetermined location known to the processor 112, or the derived location may be chosen at random. The processor 112 then constructs an overlay that includes the shopping cart of the customer 100 and shows the overlay on the display 114 at the derived location (step 440). The processor 112 then returns to a state of monitoring the right input switch 142 of the computer mouse 140 (step 410).

Otherwise (i.e., the display 114 shows an overlay that includes the shopping cart of the customer 100 when the right click is detected), the processor 112 retires the overlay, i.e., causes the overlay to be shown no longer by the display 114 (step 450). The processor 112 then returns to a state of monitoring the right input switch 142 of the computer mouse 140 (step 410).

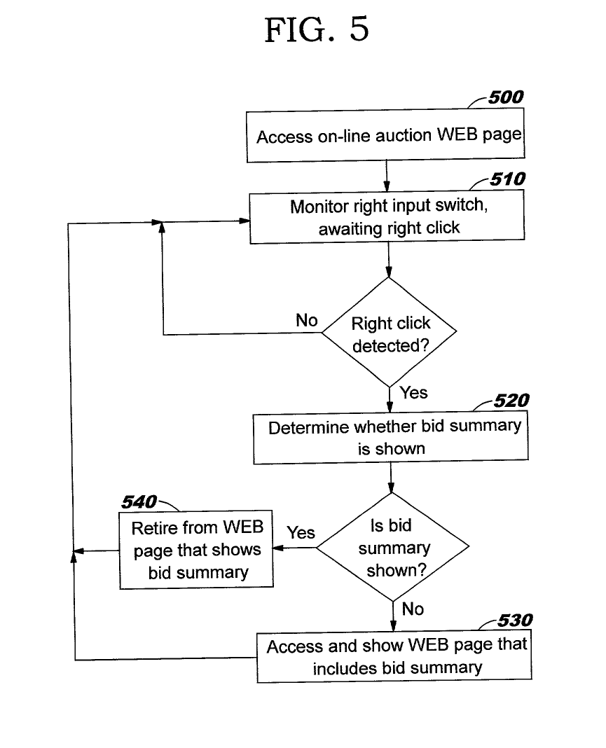

FIG. 5 shows aspects of the operation of another embodiment of the invention. In FIG. 5, the customer 100 accesses an on-line auction web page using the web browser 116 of the client 110 (step 500). The processor 112 monitors the right input switch 142 of the mouse 140 (step 510), awaiting a right click. When a right click is detected, the processor 112 determines whether the display 114 shows a web page that includes a bid summary of the customer 100 (step 520).

When the display 114 does not show a web page that includes the bid summary, the processor 112 instructs the browser 116 to access a web page on the server 120 that includes the bid summary of the customer 100, and to show that page upon the display 114 (step 530). The processor 112 then returns to a state of monitoring the right input switch 142 of the computer mouse 140 (step 510).

Otherwise (i.e., the display 114 shows a web page that includes the bid summary of the customer 100 at the time of the right click), the processor 112 instructs the web browser 116 to retire the bid summary by leaving the web page that includes the bid summary, and go to an antecedent auction page or to a subsequent auction page (step 540), i.e., to stop showing the bid summary. The processor 112 then returns to a state of monitoring the right input switch 142 of the computer mouse 140 (step 510).

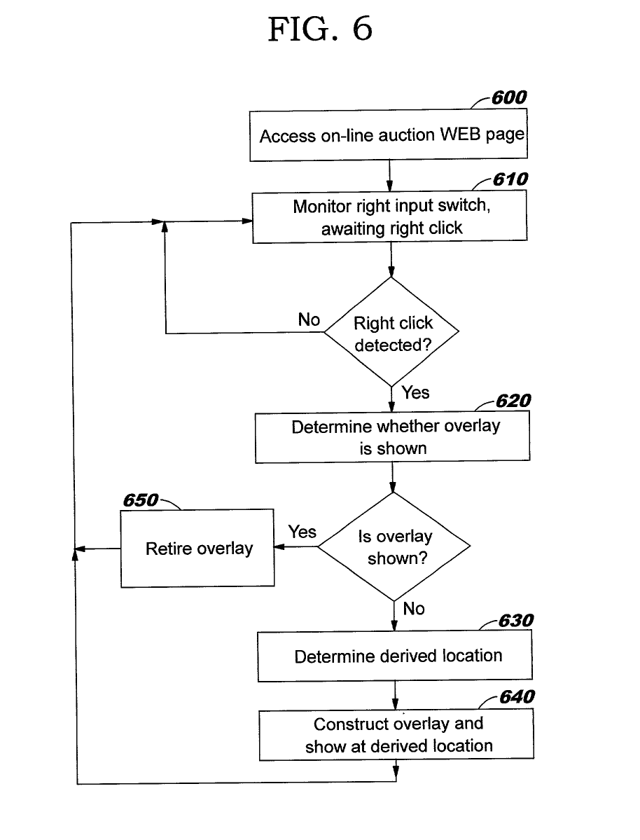

FIG. 6 shows aspects of the operation of another embodiment of the invention. In FIG. 6, the customer 100 accesses an on-line auction web page using the web browser 116 of the client 110 (step 600). The processor 112 monitors the right input switch 142 of the mouse 140 (step 610), awaiting a right click. When a right click is detected, the processor 112 determines whether the display 114 shows a web-page overlay that includes a bid summary of the customer 100 (step 620).

When the display 114 does not show a web-page overlay that includes the bid summary, the processor 112 reads the screen coordinates of the computer mouse 140 upon the display 114, and therefrom derives a screen location for showing an overlay (step 630). The derived location may be the location specified by the screen coordinates of the computer mouse 140, an offset of this location in the x or y directions upon the screen of the display 114, or some other location based upon the screen coordinates of the mouse 140. Alternately, the derived location may be a predetermined location known to the processor 112, or the derived location may be chosen at random. The processor 112 then constructs an overlay that contains the bid summary of the customer 100 and shows the overlay on the display 114 at the derived location (step 640). The processor 112 then returns to a state of monitoring the right input switch 142 of the computer mouse 140 (step 610).

Otherwise (i.e., the display 114 shows an overlay that includes the bid summary of the customer 100 at the time of the right click), the processor 112 retires the overlay, i.e., causes the overlay to be shown no longer upon the display 114 (step 650). The processor 112 then returns to a state of monitoring the right input switch 142 of the computer mouse 140 (step 610).

From the foregoing description, those skilled in the art will appreciate that the present invention makes web-based shopping activities, auction activities, barter activities, rental activities, and the like more convenient, by providing a straightforward way for the customer 100 to call up and to retire a shopping summary. The foregoing description, however, is illustrative rather than limiting, and the scope of the present invention is limited only by the following claims.

We claim:

1. A method of presenting a shopping summary associated with electronic commerce, comprising the acts of:
detecting a right click of a computer mouse on a web page; and
showing a shopping summary in response to detecting the right click.

2. The method of claim 1, wherein the act of showing further comprises the act of accessing a second web page that includes the shopping summary.

3. The method of claim 1, wherein the act of showing further comprises the act of opening a web page overlay that includes the shopping summary.

4. A method of presenting a shopping cart for on-line shopping, comprising the acts of:
detecting a right click of a computer mouse on an on-line shopping web page; and
showing a shopping cart responsive to detecting the right click of the computer mouse on the on-line shopping web page.

5. The method of claim 4, wherein the act of showing further comprises the act of accessing a second web page that includes the shopping cart.

6. The method of claim 4, wherein the act of showing further comprises the act of opening a web page overlay that includes the shopping cart.

7. A method of displaying a bidding summary for an on-line auction, comprising the acts of:
detecting a right click of a computer mouse on an on-line auction web page; and
showing a bidding summary responsive to detecting the right click of the computer mouse on the on-line auction web page.

8. The method of claim 7, wherein the act of showing further comprises the act of accessing a second web page that includes the bidding summary.

9. The method of claim 7, wherein the act of showing further comprises the act of opening an overlay that includes the bidding summary.

10. A method of presenting a shopping summary for electronic commerce, comprising the acts of:
detecting a right click of a computer mouse on a web page;
deriving a screen location from screen coordinates of the computer mouse;
creating an overlay that includes a shopping summary; and
showing the overlay upon the web page at the derived location.

11. The method of claim 10, wherein the shopping summary includes a shopping cart.

12. The method of claim 10, wherein the shopping summary includes an auction-bid summary.

13. The method of claim 10, wherein the shopping summary includes a barter summary.

14. The method of claim 10, wherein the shopping summary includes a rental summary.

15. A method for presenting a shopping summary for electronic commerce, comprising the acts of:
detecting a right click of a computer mouse on an electronic commerce web page;
when the right click is detected, determining whether a shopping summary is shown;
if the shopping summary is shown upon detection of the right click, retiring the shopping summary; and
if the shopping summary is not shown upon detection of the right click, showing the shopping summary.

16. The method of claim 15, wherein the shopping summary is included in a second web page.

17. The method of claim 15, wherein the shopping summary is included in an overlay upon the electronic commerce web page.

18. The method of claim 15, wherein the shopping summary includes a shopping cart.

19. The method of claim 15, wherein the shopping summary includes an auction-bid summary.

20. The method of claim 15, wherein the shopping summary includes a barter summary.

21. The method of claim 15, wherein the shopping summary includes a rental summary.
